(19) United States
(12) Patent Application Publication
(10) Pub. No.: US 2015/0038018 A1
(43) Pub. Date: Feb. 5, 2015

(54) INTERMEDIATE ELECTRICAL CONNECTOR

(71) Applicant: Hirose Electric Co., Ltd., Tokyo (JP)

(72) Inventor: Atsushi MATSUZAWA, Tokyo (JP)

(21) Appl. No.: 14/335,976

(22) Filed: Jul. 21, 2014

(30) Foreign Application Priority Data
Aug. 1, 2013 (JP) 2013-160733

(51) Int. Cl. H01R 24/60; H01R 13/04

(52) U.S. Cl. CPC H01R 24/60; H01R 13/04
USPC 439/638

(57) ABSTRACT

An intermediate electrical connector includes a plurality of blades including a male type blade and a female type blade; and a holding member for holding the blades. The male type blade includes a first terminal including a first contact portion disposed on a first terminal arrangement surface. The female type blade includes a second terminal including a second contact portion disposed a second terminal arrangement surface. The holding member includes a first holding portion for holding the male type blade, a second holding portion for holding the female type blade, and a third holding portion for holding the male type blade or the female type blade. The first holding portion is situated adjacent to the second handling portion. The first holding portion holds the male type blade so that the first terminal arrangement surface is opposite to the second terminal arrangement surface.

### BACKGROUND OF THE INVENTION AND RELATED ART STATEMENT

The present invention relates to an intermediate electrical connector, for connecting two mating connecting bodies with the mating connecting body being a mating connector or a circuit board.

For a conventional intermediate electrical connector of this type, for example, there is known one disclosed in Patent Reference. Patent Reference discloses a conventional intermediate electrical connector (hereinafter referred to as “intermediate electrical connector”), which is to be mounted on a mounting surface of a circuit board, a mating connecting body, and to which a circuit board connector (hereinafter referred to as “intermediate electrical connector”), another mating connecting body, is fitted and connected from thereabove.
Patent Reference: Japanese Patent Application Publication No. 2010-073641

Such a conventional intermediate electrical connector includes a plurality of blades that will be described later, and a holding member. The holding member extends in one direction parallel to the mounting surface of the circuit board, and arranges and holds the plurality of blades.

On each blade, there is provided on one sheet surface of a flat base material a plurality of terminals. The plurality of terminals extends in an up-and-down direction and is arranged in the arrangement direction of the blades. On the other plate's surface of each blade, there is provided one grounding plate. A plurality of the blades is arranged in a longitudinal direction of the holding member so as to be provided on the same surface, i.e., in a blade arrangement direction. In addition, the plurality of blades is also arranged in two rows in a connector's width direction, which is perpendicular to the blade arrangement direction. The blades arranged in two rows are provided facing inward in the connector's width direction such that plates' surfaces on sides, where terminals are provided, face each other.

In the conventional intermediate electrical connector, at upper end sides of the plurality of terminals, contact sections are formed to contact with mating terminals provided on the mating connector, extending straight in the up-and-down direction. At lower end sides, connecting sections to connect to corresponding circuit units of a circuit board is formed being bent perpendicular to the up-and-down direction. These blades are so-called male blades, in which the contact sections are secured on substrates. Hereunder, the terminals provided on the male blades are referred to as “male terminals”. Any blade in the plurality of blades to be held in the holding member of the intermediate electrical connector is a male blade. In other words, in the intermediate electrical connector, there are provided two male blade rows composed of only male blades having the same shapes. Upper-end sections of the blades, i.e., parts where the contact sections of the male terminals are provided, protrude upward from upper end surface of the holding member. The upper end sections of the blades work as fitting sections to fit to the mating connector.

On the other hand, corresponding to male terminals of the plurality of male blades of the intermediate electrical connector, the mating terminals are arranged and held in the housing. In the housing, there are formed two concave sections opened downward to receive the fitting sections of the intermediate electrical connector, i.e., the upper end sections of the male blades, respectively corresponding to the two male blade rows. The mating terminals are so-called “female terminals”, which curve convexly in the connector's width direction and can be elastically displaced in the connector's width direction.

In the conventional intermediate electrical connector, the female terminals are arranged in two rows corresponding to the male blades of the intermediate electrical connector. The two rows of female terminals are arranged, such that corresponding contact sections protrude outward in the connector's width direction in each row, i.e., the corresponding contact sections protrude in a direction to be away from each other in the connector's width direction, and the respective contact sections are provided protruding to the respective corresponding concave sections. Between the two concave sections, there is provided a center wall that divides the concave sections.

In the conventional intermediate electrical connector, on both side surfaces of the center wall, there is securely provided space to allow elastic displacement of the corresponding contact sections of the respective female terminals in the connector's width direction by a groove section extending in the up-and-down direction. In a state that the intermediate electrical connector and the mating connector are fitted, the corresponding contact sections of the two rows of the female terminals elastically displace, such that the corresponding contact sections become close to each other in the connector's width direction and contact with the contact sections of the male terminals of the intermediate electrical connector with certain contact pressure. At this time, unexpected contact between elastic contact sections is prevented by the dividing walls present between the grooves in the connector's width direction.

As described above, according to the conventional intermediate electrical connector of Patent Reference, any blades arranged in plurality in the blade arrangement direction and are held in two rows in the holding member in the connector's width direction are male blades. Therefore, any mating terminals provided in the mating connector for fitting and connecting to the intermediate electrical connector are all female terminals. The female terminals arranged in two rows elastically displace so as to have corresponding contact sections close to each other in the connector's width direction. Therefore, it is necessary to provide dividing walls between the female terminals in order to prevent unnecessary contact between the corresponding contact sections. In addition, even when such dividing wall is not provided, it is still necessary to form space between the female terminals in the connector's width direction so as to secure enough distance between the elastically displaced corresponding contact sections.

Therefore, as in Patent reference, when the two rows of the female terminals, which are adjacent to each other, elastically displace, the size of the housing and in turn the size of the mating connector as a whole has to be large in the connector's width direction for forming the dividing walls and the space between the female terminals, in comparison with when the two adjacent rows of female terminals are arranged so to elastically displace in the same direction or when at least one of the adjacent two rows is made as a row of male terminals, contact sections of which do not elastically displace.

The influence of such size increase of the intermediate electrical connector and the mating connector in the connector's width direction is significant as the number of terminal pairs of the female terminal arranged so as to protrude in a direction to have the corresponding contact sections away from each other, and as the number of the blade rows in the intermediate electrical connector is large.

In view of the problems described above, an object of the invention is to provide an intermediate electrical connector capable of satisfactorily preventing the size increase of the connector in the connector's width direction.

Further objects and advantages of the present invention will be apparent from the following description of the present invention.

### SUMMARY OF THE PRESENT INVENTION

In order to attain the objects described above, according to a first aspect of the present invention, an intermediate electrical connector includes a plurality of blades, and a holding member. On each of the plurality of blades, there is provided a plurality of terminals, which respectively extends between an upper end side and a lower end side of a flat substrate and has contact sections or connecting sections on the upper end side and the lower end side. The holding member arranges and holds the plurality of blades with an arrangement direction of the blades being an arrangement direction of the terminals. To the blades, a mating connector or a mating connecting body that is a circuit board is connected at the upper end side and the lower end side thereof.

According to the first aspect of the invention, the plurality of blades includes male blades and female blades. On each male blade, the contact sections of the terminals are arranged on a side of one plate's surface of the male blade and secured on the substrate. On each female blade, the contact sections of the terminals are arranged on the other plate's surface thereof and are provided on the substrate in a state the contact sections are elastically displaceable in the connector's width direction, a direction perpendicular to the plate's surface. The holding member holds at least three rows of blades in the connector's width direction. Each blade row is a homo blade row composed of only male blade rows or female blade rows arranged in the blade arrangement direction, or hetero blade row, which is a mixed row, in which the male blades and the female blades are suitably mixed.

According to the first aspect of the present invention, among the at least three blade rows, in at least one blade row pair composed of two blade rows that are adjacent to each other in the connector's width direction, blades are arranged, such that terminal arrangement surfaces, plates' surfaces of the blades provided on a side of contact surfaces of the terminals are provided opposite to each other in the connector's width direction. In the two blade rows that form the blade row pair, the male blades are provided in the both blade rows, or the male blade is provided in one blade row and the female blade is provided in the other blade row.

In the intermediate electrical connector, when any blade rows are female blade rows, in at least one female blade pair composed of two blade rows that are adjacent to each other, when the female blades are arranged such that the terminal arrangement surfaces are provided opposite to each other, it is necessary to secure sufficient distance between the female blade rows in the connector's width direction, in order to prevent unexpected contact between the terminals of the elastically displaced female blades. For this reason, the size of the intermediate electrical connector has to be large in the connector's width direction.

Furthermore, in the intermediate electrical connector, when any blade rows are male blade rows, it is necessary to have the terminals in all the terminal rows be female terminals in the mating connector as the mating connecting body. Therefore, when the mating connector has female blade pair, in which their terminal arrangement surfaces are provided opposite to each other, the size of the mating connector has to be large in the connector's width direction. Therefore, the intermediate electrical connector also has to be large in the connector's width direction.

According to the first aspect of the invention, the blade rows are male blade rows, female blade rows, or mixed blade rows thereof. Two blade rows, a blade row pair, in which the terminal arrangement surfaces are provided opposite to each other in the connector's width direction, at the same positions in the blade arrangement direction, the male blades are provided in the both blade rows, or male blades are provided in one blade row and female blades are provided in the other blade row. In short, the female blades will not be provided in both blades at the same positions in the blade arrangement direction. Therefore, in the blade row pair, there will be no contact between the terminals of the elastically displaced female blades. As a result, it is not necessary to secure a distance between the female blades in order to prevent the contact between the terminals of the female blades. Accordingly, it is possible to reduce the sizes of the intermediate electrical connector and the mating connector thereof in the connector's width direction.

According to a second aspect of the invention, at least one blade row can include a different type of blades according to characteristics of signals to transmit. Mixing different types of blades in at least one of the male blade rows and the female blade rows, it is possible to transmit various types of signals. In addition, according to the intermediate electrical connector of the invention, the terminals are not directly held by the housing, but blades holding the terminals are arranged and held. Therefore, arranging desired type of blades in each blade row, it is possible to easily change the arrangement of the terminals according to characteristics of signals to transmit.

According to a third aspect of the invention, the terminals of each blade can be made from a terminal material. The terminal material has a shape, in which a plurality of strip pieces that extends in an up-and-down direction and is adjacent to each other is joined by joining sections at one or more points. In such blade, at least one joining section may be suitably removed from the terminal material according to the characteristics of signals to transmit by the blade. Alternatively, in such blade, the joining sections may not be removed from the terminal material. Even when a plurality of types of terminals are necessary according to characteristics of signals to transmit, according to the third aspect of the invention, it is possible to make a plurality of types of terminals from a terminal material having one shape. Therefore, it is also possible to significantly reduce the manufacturing cost.

According to a fourth aspect of the invention, the housing has accommodating sections for accommodating and holding the respective blades that are pressed in from thereabove or thereunder. Each blade has press-in protrusions that protrude outward in the terminal arrangement direction from side edges in the terminal arrangement direction. With the press-in protrusions engaging onto inner wall surfaces of the accommodating sections, the blades are held in the accommodating sections. The press-in protrusions may be formed by the joining sections that protrude outward in the terminal arrangement direction from terminals provided on the both edges among the plurality of terminals provided in the blade.

The terminal material has a joining section between strip pieces that are adjacent to each other. Therefore, no matter with the necessary number of strip pieces for making the terminals to provide in one blade, it is possible to form the press-in protrusions by leaving at least a part of the joining sections that protrude outward in the terminal arrangement direction from the strip pieces of the terminals provided on edges, upon cutting the joining sections of the terminal material according to the number of the strip pieces, in the manufacturing process of the blade. Moreover, the press-in protrusions are a part of the terminal material, which is a metal member, so that the strength of the press-in protrusion themselves is large. Accordingly, the press-in protrusions engage onto the inner wall surfaces of the accommodating sections of the holding member, and thereby it is possible to securely prevent coming off of the blade.

According to a fifth aspect of the invention, the press-in protrusions that protrude from the both side edges of each blade are preferably provided at positions that are different from each other in the up-and-down direction. Providing the press-in protrusions at different positions in the up-and-down direction in this way, it is possible to position the press-in protrusions provided at side edges that face each other between adjacent blades, without interference from each other but with some overlaps in the blade arrangement direction. Therefore, it is possible to reduce the size of the connector in the blade arrangement direction by having the side edges of the adjacent blades close to each other.

According to a sixth aspect of the invention, at least one blade row among the blade rows provided in the intermediate electrical connector is male blade row. Other blade rows than the male blade row(s) are female rows. In each male blade row, the connecting sections of the terminals are provided only on one side of the terminal arrangement surfaces of the male blade in the connector's width direction. In each female blade, the connecting sections of the terminals can be provided only on one side of the terminal arrangement surfaces of the female blade in the connector's width direction.

When there is provided a plurality of blade rows in the connector, the connecting sections of the blades in each blade row are often provided on an outer side of the terminal arrangement surfaces in the connector's width direction. In other words, the connecting sections of blades in blade rows provided on one side and the other side relative to a center in the connector's width direction are provided only on one side of their terminal arrangement surfaces that are away from the center in the connector's width direction, no matter with which direction the terminal arrangement surfaces are directed in the connector's width direction. Therefore, in a case any blade rows provided in the connector are homo blade rows, i.e., only male blade rows or female blade rows, as conventional, it is necessary to prepare both blades, one of which has a shape having terminals on one side and the other of which has a shape having terminals on the other side of the terminal arrangement surfaces.

According to the sixth aspect of the invention, there is no mixed blade rows provided, and the male blade rows and the female blade rows are provided. Moreover, the connecting sections of the male blades are provided on one side of the terminal arrangement surfaces. In addition, the connecting sections of the female blades are provided on the other side of the terminal arrangement surfaces. In other words, there are only one type each of the male blades and female blades. For example when only male blade rows are provided in the connector as conventional, as described above, it is necessary to prepare two types of blade blades. According to the sixth aspect of the invention, however, replacing one of the two types of male blades with the female blade of the invention, it is possible to have the connecting sections of the terminals in any blade rows present on sides of the terminal arrangement surfaces, which are away from the center in the connector's width direction. In addition, even in a case only female blade rows are conventional provided in the connector, according to the sixth aspect of the invention, replacing one type of the two types of female blades with the male blades of the invention, it is possible to have the connecting sections of the terminals on one sides similarly to the above.

Furthermore, according to the sixth aspect of the invention, it is necessary to prepare only one type each of the male blades and the female blades. Therefore, it is possible to significantly reduce the manufacturing cost in comparison with a case it is necessary to prepare two types each of blades for each type (female or male blades).

According to a seventh aspect of the invention, the plurality of the terminals provided in each blade is composed of signal terminals and grounding terminals. Each grounding terminal may be arranged to be provided on both sides of two signal terminals in the terminal arrangement direction. The plurality of terminals provided in each blade is arranged such that each grounding terminal is provided at both sides of two signal terminals in the terminal arrangement direction, so that it is possible to use the connector for transmitting high-speed differential signals.

According to an eighth aspect of the invention, in the terminals provided in two blades that are adjacent and face each other in the connector's width direction, the signal terminals provided on one blade may face the grounding terminals provided on the other blade in the connector's width direction. Arranging the signal terminals and grounding terminals in this way, it is possible to arrange the grounding terminals on both sides of two signal terminals not only in the terminal arrangement direction, but also in the connector width direction. As a result, the grounding terminals are arranged to surround two signal terminals. Therefore, it is possible to improve a shielding effect on the signal terminals and thereby it is possible to more securely transmit high-speed signals.

According to a ninth aspect of the invention, the blade rows may be provided in four rows.

### BRIEF DESCRIPTION OF THE DRAWINGS

FIG. 1 is a perspective view showing an intermediate electrical connector according to an embodiment of the invention and a mating connector thereof in a state before fitting to each other;

FIG. 2 is a perspective view of the intermediate electrical connector and the mating connector of FIG. 1 in a state that the connectors are fitted to each other;

FIG. 3 is a sectional view of the intermediate electrical connector and the mating connector of FIG. 1, taken at a surface perpendicular to a blade arrangement direction, in a state before fitting to each other;

FIG. 4 is a sectional view of the intermediate electrical connector and the mating connector of FIG. 1, taken at a surface perpendicular to the blade arrangement direction, in a state the connectors are fitted to each other;

FIGS. 5(A) and 5(B) are perspective views of a female blade, wherein FIG. 5(A) shows a side of a terminal arrangement surface and FIG. 5(B) shows a side of a grounding plate attachment surface;

FIGS. 6(A) and 6(B) are perspective views of a male blade, wherein FIG. 6(A) shows a side of a terminal arrangement surface and FIG. 6(B) shows a side of a grounding plate attachment surface;

FIG. 7 is a perspective view of the intermediate electrical connector and the mating connector of FIG. 1 in a state before some blades are inserted in the connectors;

FIG. 8 is a partial sectional view of the intermediate electrical connector of FIG. 1, taken at a surface perpendicular to a width direction thereof;

FIG. 9 is a front view of a terminal material;

FIG. 10 is a front view of the terminal material, in which strip pieces that do not have mating terminals are removed from the terminal material of FIG. 9;

FIG. 11 is a front view of the terminal material of FIG. 10 that is integrally molded with a substrate;

FIG. 12 is a front view of a complete female blade;

FIG. 13 is a front view of a female blade according to a modification example; and

FIG. 14 is a front view of a female blade according to another modification example.

### DETAILED DESCRIPTION OF THE PREFERRED EMBODIMENTS

Hereunder, an embodiment of the present invention will be described with reference to the accompanying drawings.

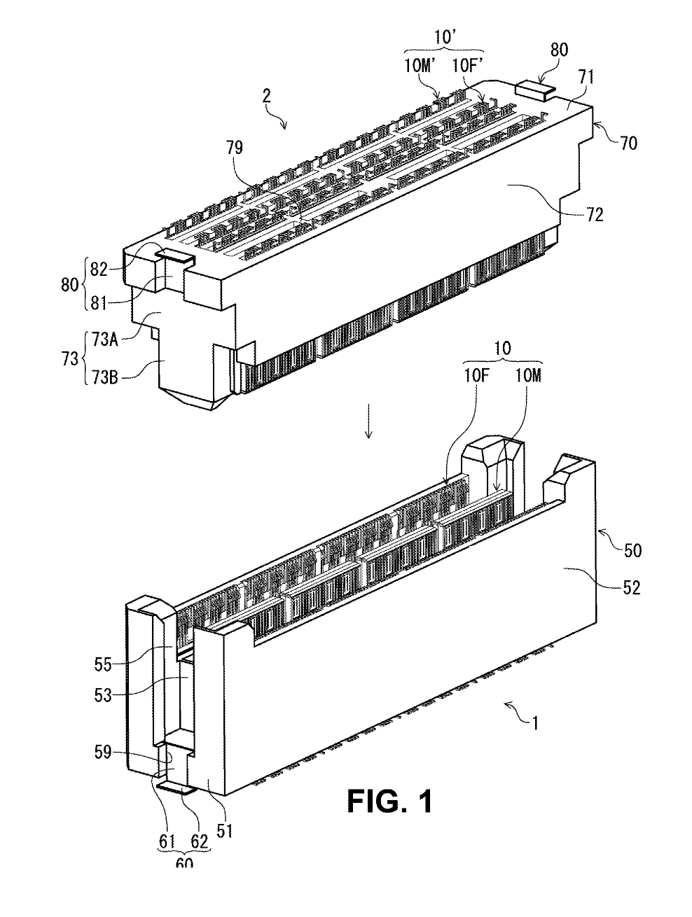

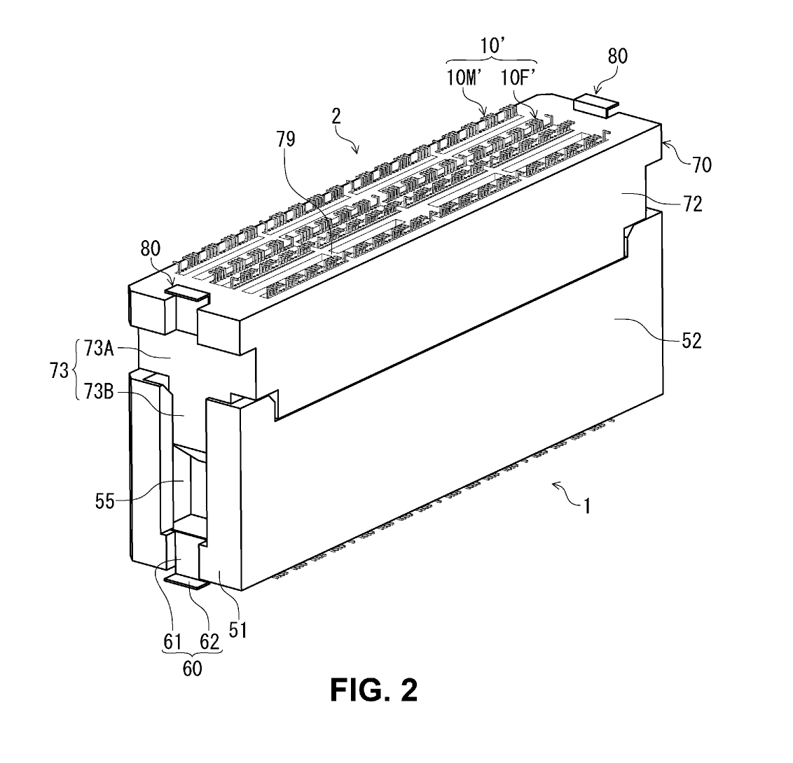

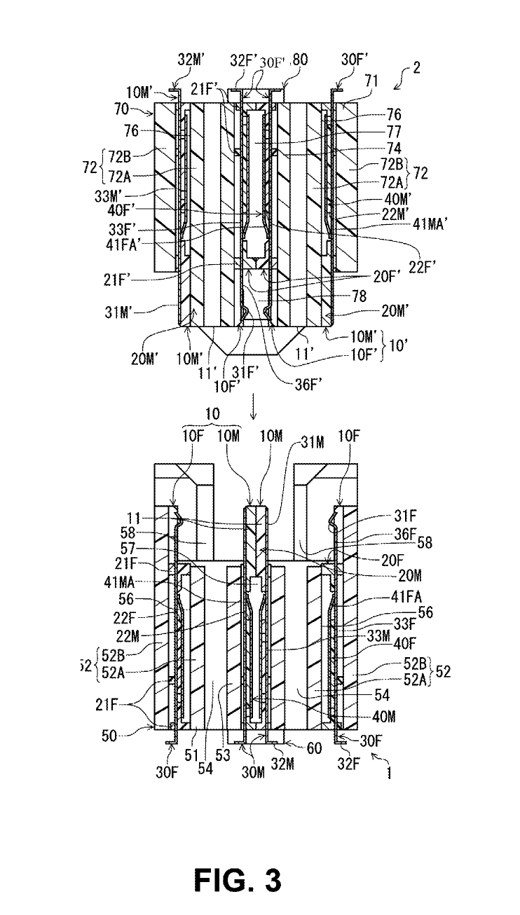

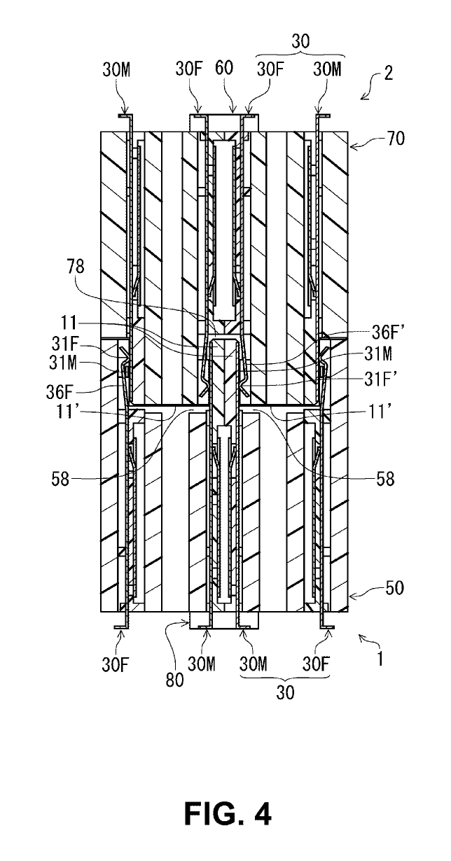

FIG. 1 is a perspective view of a connector according to an embodiment of the invention and a mating connector thereof in a state before fitting the connectors. FIG. 2 is a perspective view of the connector and the mating connector of FIG. 1 in a state the connectors are fitted to each other. FIGS. 3 and 4 are sectional views of the connector and the mating connector of FIG. 1, taken at a surface perpendicular to a blade arrangement direction, wherein FIG. 3 shows a state before fitting the connectors and FIG. 4 shows a state the connectors are fitted.

The electrical connector 1 according to the embodiment (hereinafter simply referred to as “connector 1”) is disposed on a mounting surface of a circuit board (not illustrated), a mating connecting body, and is connected to a corresponding circuit unit of the circuit board. The connector 1 is also fitted and connected to a mating connector 2, another mating connecting body, from thereabove. In other words, the connector 1 is an electrical connector for mounting on a circuit board, which serves as an intermediate electrical connector that relays between the circuit board and the mating connector 2. On the other hand, the mating connector 2 is another electrical connector for mounting on a circuit board, which is disposed on a mounting surface of another circuit board (not illustrated) that is different from the one the connector 1 is mounted, and is connected to a corresponding circuit unit of the another circuit board.

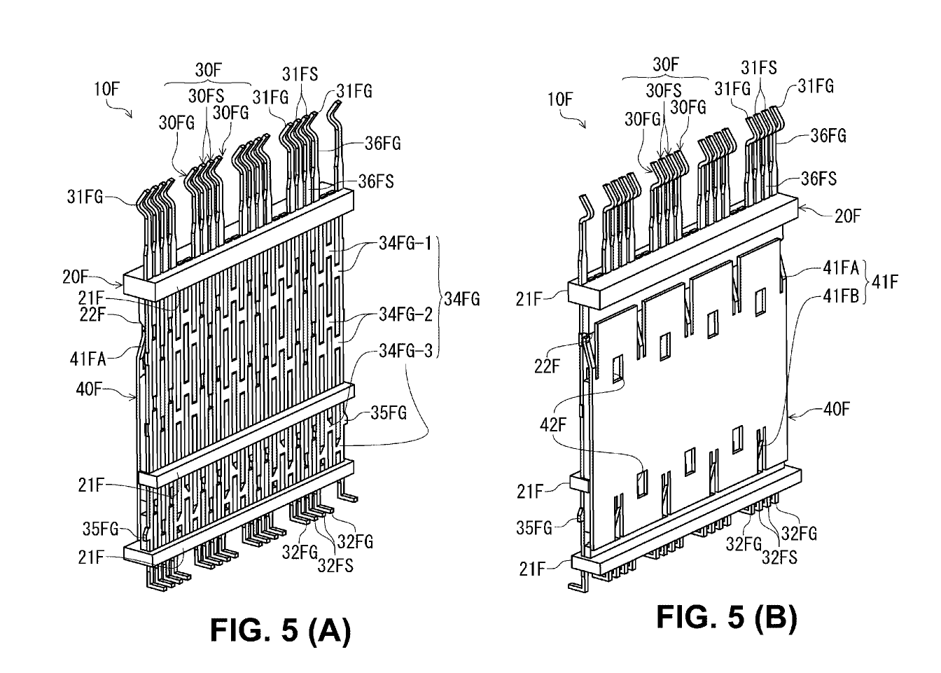

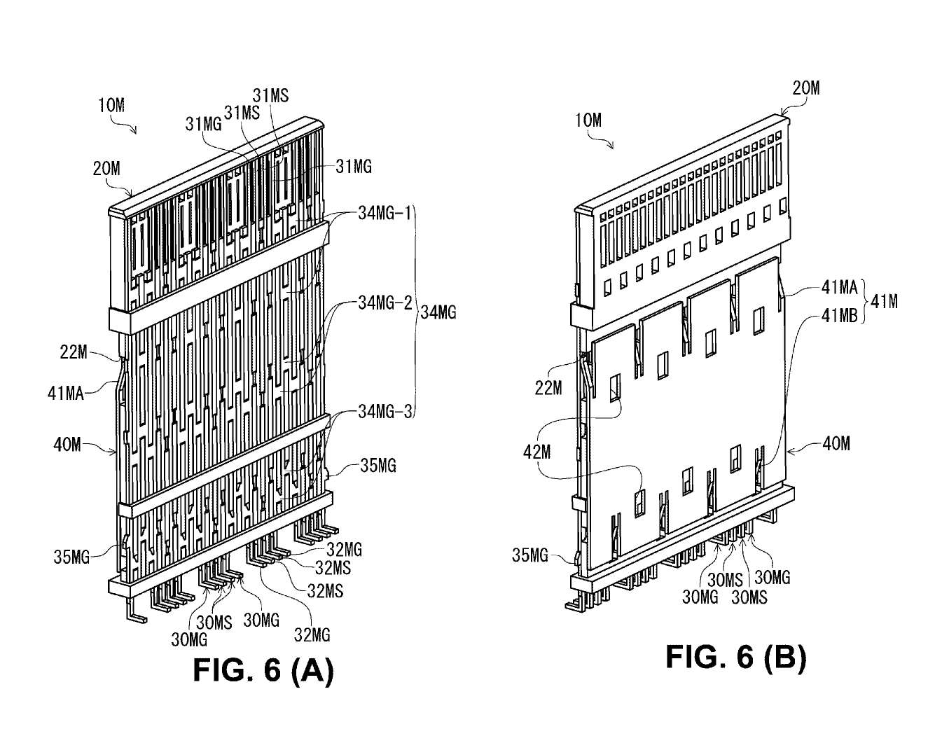

The connector 1 includes a plurality of flat blades 10 (see also FIGS. 5 and 6), a housing 50, which is a holding member to arrange and hold the plurality of blades 10, and securing metal fittings 60 held in the housing 50. Each blade 10 is made such that a plurality of terminals 30, which extend in an up-and-down direction, is arranged on one plate's surface of a flat resin substrate 20 and a grounding plate 40 is attached on the other plate's surface of the substrate 20. Hereunder, the one plate's surface of the substrate 20, a plate's surface on a side of contacting surfaces of contact sections of terminals 30, which will be described later, is referred to as “a terminal arrangement surface” and the other plate's surface is referred to as “a grounding plate attachment surface”.

As shown in FIG. 1, the housing 50 generally has an outer shape of a rectangular parallelepiped, extending with a longitudinal direction being one of directions parallel to a mounting surface of the circuit board. According to the embodiment, the housing 50 arranges and holds four blades 10 in the longitudinal direction so as to have them on the same flat surface, and holds four rows of blades, each of which is composed of four blades, in a lateral direction, a direction perpendicular to the longitudinal direction. In other words, the housing 50 holds total 16 blades. Hereinafter, the longitudinal direction is referred to as a “blade arrangement direction” and the lateral direction is referred to as a “connector's width direction”.

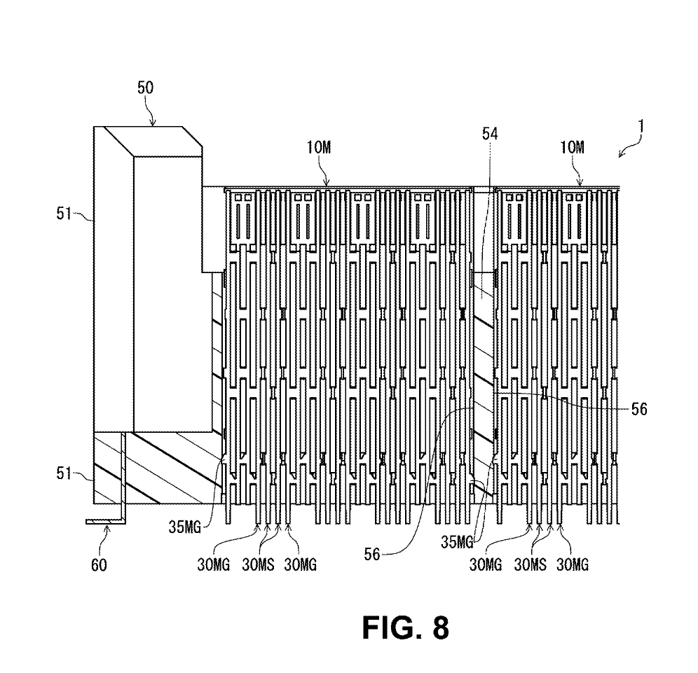

The housing 50 includes a bottom wall 51 that faces the mounting surface of the circuit board, two side walls 52 that rise upward from the bottom wall 51 and extend in the blades' arrangement direction, a center wall 53 that rises upward from the bottom wall 51 and extends in the longitudinal direction between the two side walls 52, and dividing walls 54 (see FIGS. 3 and 8) that extend in the connector's width direction so as to correspond to the spaces between adjacent blades in the blades' arrangement direction and connect the side walls 52 and the center wall 53.

As shown in FIG. 1, each side wall 52 has a lower section at where the blades are arranged, which is lower than the two end sections thereof in the blade arrangement direction, i.e., outside the blade arrangement section. Between the end sections of each side wall 52 in the connector's width direction, there is formed space opened upward and outward in the blade arrangement direction. The spaces form concave sections 55 to receive narrow sections 73B, which will be described later, of corresponding end walls 73 of the mating connector 2 upon fitting to the mating connector 2 (see FIG. 2).

As shown in FIG. 3, the each side wall 52 has an inner wall section 52A, inner part of the side wall 52 in the connector's width direction (in a left-and-right direction in FIG. 3), is formed lower than an outer wall section 52B, which is an outer part of the side wall 52, and has a step-like shape when viewed in the blade arrangement direction (a direction perpendicular to the paper surface of FIG. 3). The outer wall sections 52B have the same dimensions as the blades 10 in the up-and-down direction. On each inner wall section 52A, there is formed blade accommodating sections 56 for holding the blades 10. The blade accommodating sections 56 are formed as holes penetrating also the bottom wall 51 in the up-and-down direction. The blade accommodating sections 56 are arranged in 4 rows in the blade's arrangement direction. The Each blade accommodating section 56 has generally the same dimension as one blade 10 in the blade arrangement direction and the connector's width direction. Therefore, each blade accommodating sections 56 is designed to accommodate one blade 10 (a female blade 10F, which will be described later).

As shown in FIG. 3, the center wall 53 is formed to have the same dimensions as the inner wall sections 52A of the side walls 52 in the up-and-down direction and an upper surface of the center wall 53 is located at the same height as upper surfaces of the inner wall section 52A. On the center wall section 53, there are formed blade accommodating sections 57 for accommodating and holding the blade 10 as holes penetrating even the bottom wall 51 in the up-and-down direction, and the blade accommodating sections 57 are arranged in four rows in the blade arrangement direction. Each blade accommodating section 57 has generally the same dimension as that of one blade 10 in the blade arrangement direction, and has generally the same dimension as that of two blades 10 in the connector's width direction. As well shown in FIG. 3, each blade accommodating section 57 is configured to accommodate two blades 10 (male blades 10M) while having plate's surfaces of the blades 10 put together.

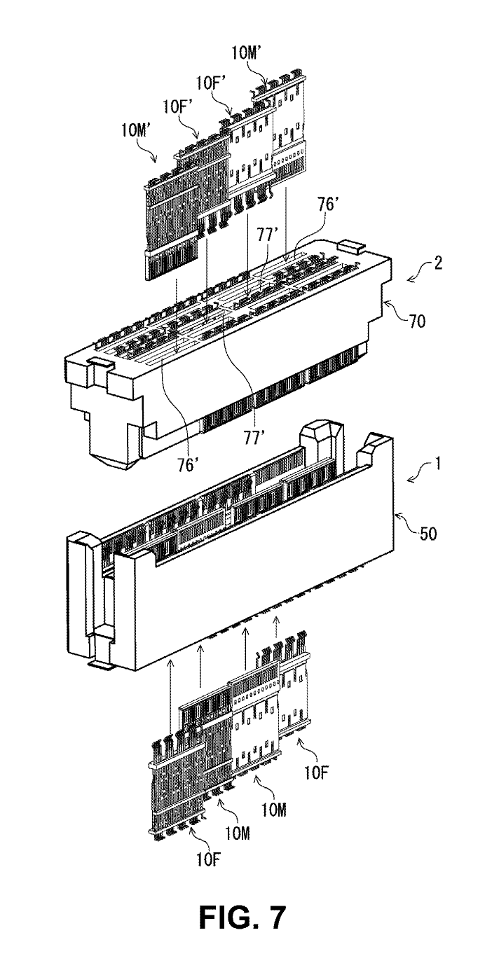

Into those blade accommodating sections 56 and 57, the blades 10 are pressed in from thereunder (see FIG. 7), and as will be described later, held by press-in protrusions 35MG and 35FG provided on both edges (edges extending in the up-and-down direction) of the blades 10 (see FIG. 8).

Each dividing wall 54 is formed to have the same dimension as that of the inner wall section 52A of the side wall 52 and the center wall 53 in the up-and-down direction. The dividing walls 54 have their upper surfaces at the same height as the upper surfaces of the inner wall section 52A and the center wall 53.

The blades 10 include male blades 10M having male terminals 30M and female blades 10F having female terminals 30F, which will be described later. FIGS. 5(A) and 5(B) are perspective views of the female blade 10F, wherein FIG. 5(A) shows a side of a terminal arrangement surface and FIG. 5(B) shows a side of a grounding plate attachment surface. FIGS. 6(A) and 6(B) are perspective views of the male blade 10M, wherein FIG. 6(A) shows a side of a terminal arrangement surface and FIG. 6(B) shows a side of a grounding plate attachment surface. The male blades 10M and the female blades 10F are made to have the same dimensions in the up-and-down direction and the terminal arrangement direction, respectively.

As shown in FIG. 3, according to the embodiment, any blades 10 held in the blade accommodating sections 56 of the two side walls 52 are female blades 10F, and any blades 10 held in the blade accommodating sections 57 of the center wall 53 are male blades 10M. In short, the blade rows held by the side walls 52 are female blade rows formed by arranging only the female blades 10F, whereas the blade rows held by the center wall 53 are male blade rows formed by arranging only male blades 10M.

According to the embodiment, as shown in FIG. 6(A), the male terminals 30M are terminals having straight contact sections 31M. The contact sections 31M are provided being secured on the substrates 20M of the male blades 10M. On the other hand, as shown in FIG. 5(A), the female terminals 30F are terminals having bent contact sections 31F. The contact sections 31F are provided on the substrates 20F of the female blades 10F while being elastically displaceable in the plate's thickness direction of the female blades 10F. As will be described, the male terminals 30M and the female terminals 30F are made from terminal materials obtained by punching while keeping flat surfaces of a sheet metal member.

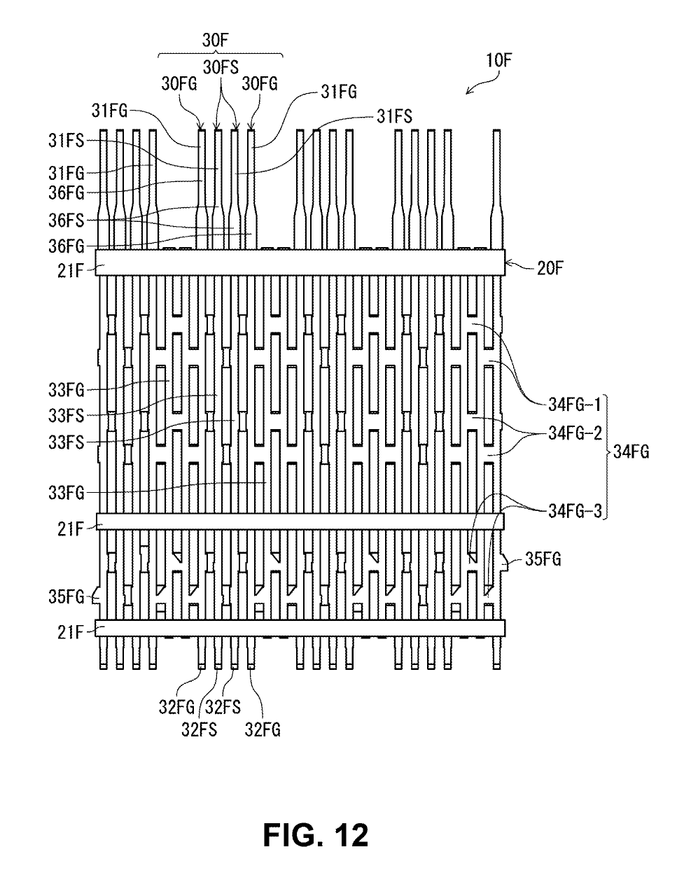

Next, based on FIGS. 5(A) and 12, shapes of the female terminals 30F will be described. FIG. 12 is a front view of the female blade 10F viewed from a side of the terminal arrangement surface. As shown in FIG. 12, the female terminals 30F of the female blade 10F are composed of female signal terminals 30FS and female grounding terminals 30FG. Each female terminal 30F includes a contact section 31F for contacting with a mating terminal at an upper end side thereof, a connecting section 32F to be connected to a circuit board at a lower end side thereof, and a middle section 33F that extends in the up-and-down direction and connects the contact section 31F and the connecting section 32F. Hereunder, when it is necessary to distinguish between the female terminals 30FS and the female grounding terminals 30FG, each part of the female terminals 30F is indicated with corresponding reference numeral affixed with “S” or “G”.

As shown in FIGS. 5(A), 5(B), and 12, each female terminal 30F includes an elastic arm 36E and a contact section 31F, which extend upward from an upper end of the substrate 20F, and the connecting section 32F is provided on the substrate 20F while extending downward from a lower end of the substrate 20F. As shown in FIG. 5(A), the contact section 31F is formed being bent to be convexly curved towards a side of the grounding plate attachment surface of the substrate 20F in the plate's thickness direction of the female blade 10F (see also FIG. 3). The contact sections 31F are displaceable in the plate's thickness direction by elastic deformation of the elastic arms 36F (upper end portions of the middle sections 33F), which extend continuously to the contact section 31F, in the direction.

In addition, each connecting section 32F is formed being bent at right angle towards an opposite side to a contact surface (a plate's surface that is convexly curved) of the contact section 31F in the plate's thickness direction. In short, the connecting sections 32F are provided to protrude to an opposite side to the terminal arrangement surface relative to the terminal arrangement surface of the female blade 10F in the plate's thickness direction.

As shown in FIG. 12, each female signal terminals 30FS is made of one strip piece that extends in the up-and-down direction. On the other hand, each female grounding terminal 30FG is made by joining four strip pieces respectively at three points with joining sections 34FG in the up-and-down direction. Those three joining sections 34FG are referred to as “upper joining section 34FG-1”, “middle joining section 34FG-2”, and “lower joining section 34FG-3”, respectively in the order from the upper side. Here, according to the embodiment, only the female grounding terminal 30FG disposed on the left end in FIG. 12 is made of one strip piece similarly to the female signal terminals 30FS.

As well shown in FIG. 12, the upper joining sections 34FG-2 and the lower joining sections 34FG-3 are arranged to be staggered in their respective arrangement directions (in left-and-right directions in FIG. 12). Moreover, the upper joining sections 34FG-1 and the middle joining sections 34FG-2 are formed to be straight in the terminal arrangement direction, i.e. to keep the same dimensions through their whole length in the terminal arrangement direction. On the other hand, among the lower joining sections 34FG-3 arranged in a staggered manner, each lower joining sections 34FG-3 provided on an upper side thereof has an upper edge that slopes downward as it goes rightward in FIG. 12, and each lower joining section provided on a lower side thereof has a an upper edge that slopes downward as it goes leftward in FIG. 12.

As shown in FIG. 12, in case of the female grounding terminals 30FG, in the four strip pieces that compose the female grounding terminal 30FG, upper end sections and lower end sections of the two strip pieces located on an inner side in the terminal arrangement direction are removed. The strip pieces provided on both sides of the two strip pieces that are arranged inside have contact sections 31FG and connecting sections 32FG at upper ends thereof and lower ends thereof, respectively.

As shown in FIG. 12, according to the embodiment, the female signal terminals 30FS and the female grounding terminals 30FG are arranged, such that the female grounding terminals 30FG are disposed on both sides of two female signal terminals 30FS that are adjacent to each other in the terminal arrangement direction. Those two female signal terminals 30FS are configured to transmit high-speed differential signals.

Furthermore, as shown in FIG. 12, on a lower part of strip pieces of the female grounding terminals 30FG disposed at both ends in the terminal arrangement direction, there are formed press-in protrusions 35FG that protrude outward in the terminal arrangement direction. Each press-in protrusion 35FG is provided protruding outward in the terminal arrangement direction than side edges of the female blade 10F, i.e., side edges on both sides of the substrate 20F (see also FIG. 5(A)). As such, since the press-in protrusions 35FG are formed as a part of metal member, the press-in protrusions 35FG have high strength by themselves. Therefore, the press-in protrusions 35FG firmly engage onto inner wall surfaces of the blade accommodating sections 56 and 57 of the housing 50, so that it is possible to surely prevent the female blades 10F from coming off therefrom.

In addition, as shown in FIG. 12, the press-in protrusions 35FG are formed from the lower joining section 34FG-3 that protrude outward in the terminal arrangement direction from the female grounding terminals 30FG disposed on the both edges. More specifically, the press-in protrusion 35FG formed on the right side in FIG. 12 is formed from the lower joining section 34FG-3 formed at an upper position among those arranged in a staggered manner.

On the other hand, the press-in protrusion 35FG formed on the left side in FIG. 12 is formed from the lower joining section 34FG-3 formed at a lower position. In other words, the press-in protrusions 35FG on both sides of the female blade 10F are provided at different positions from each other in the up-and-down direction. Therefore, it is possible to dispose the press-in protrusions 35FG provided at side edges, which face each other between adjacent female blades 10F, in the blade arrangement direction, with some overlapping to each other but without interference to each other. Therefore, it is possible to reduce the size of the connector 1 in the blade arrangement direction by having the side edges of the adjacent female blades 10F close to each other.

Moreover, an upper edge of each press-in protrusion 35FG is formed as a beveled edge that slopes downward towards outside in the terminal arrangement direction. Therefore, when the female blades 10F are inserted to the blade accommodating sections 56 and 57 of the housing 50 from thereunder, the press-in protrusions 35FG easily engage onto the inner wall surfaces of the blade accommodating sections 56 and 57 of the housing 50, and thereby the female blades 10F are securely held therein.

The substrate 20F for holding the female terminals 30F is formed like a flat plate in a dimension so as to include the terminal arrangement range in the terminal arrangement direction and has a dimension to cover a range corresponding to the middle sections 33F (except the elastic arms 36F) of the female terminals 30F in the up-and-down direction. Each substrate 20F covers the plate surfaces of the female terminals 30F on sides of their contact surfaces of the contact sections 31F in the plate's thickness direction of the female terminals 30F, and also have a plurality of thin wall sections 21F that extend in the terminal arrangement direction on a side opposite the contact surfaces as shown in FIGS. 5(A) and 12,

The thin wall sections 21F protrude from three positions in the up-and-down direction at a plate's surface of each female terminal 30F and extend over the terminal arrangement range in the terminal arrangement direction. As shown in FIG. 3, in a state the female blades 10F are accommodated in the blade accommodating sections 56 of the housing 50, the thin wall sections 21 are provided between the inner wall surfaces of the blade accommodating sections 56 and the female terminals 30F in the connector's width direction. Therefore, as a result, there is formed a space between the contact sections 31F and the elastic arms 36F of the female terminals 30F and the inner wall surfaces of the blade accommodating sections 56. The space allows the elastic deformation of the elastic arms 36F, which works outward in the direction, and in turn allows the displacement of the contact sections 31F.

Furthermore, each substrate 20F has holes 22F (see FIGS. 3 and 5) that penetrate in the plate's thickness direction corresponding to the grounding contact pieces 41F of the grounding plates 40, which will be described later. Those holes 22F allow contact of the grounding contact pieces 41F to the female grounding terminals 30FG. In addition, each substrate 20F also has other holes that penetrate in the plate's thickness direction at positions corresponding to the joining sections 34F of the female terminals 30F.

As shown in FIG. 5(B), each grounding plate 40F is made by punching a sheet metal member in the plate's thickness direction thereof and bending in the plate's thickness direction to form grounding contact pieces 41F, which will be described later. As shown in FIG. 5(B), the grounding plate extends over the whole area of the female blade 10F in the terminal arrangement direction and in a range corresponding to the middle sections 33F (except the elastic arms 36F) of the female terminals 30F in the up-and-down direction.

On an upper edge section and a lower edge section of each grounding plate 40F, there are formed grounding contact pieces 41F, which can elastically displace in the plate's thickness direction of the female blades 10F, corresponding to the female grounding terminals 30FG in the terminal arrangement direction. The grounding contact pieces 41F are bent towards the female grounding terminals 30FG in the plate's thickness direction, enter the holes 22F of the substrate 20F, and contact with the female grounding terminals 30FG at certain contact pressure at their ends. Hereunder, the grounding contact pieces 41F at upper edge section of the grounding plate 40F are referred to as “upper contact pieces 41FA”, and the grounding contact pieces 41F of the lower edge sections are referred to as “lower contact pieces 41FB”. The grounding contact pieces 41F are configured, such that each upper contact piece 41FA contacts with one of the two strip pieces (strip pieces provided at both ends in the terminal arrangement direction), on which the contact sections 31FG and the connecting sections 32FG of the female grounding pieces 30F are formed, and the lower contact piece 41FB contacts with the other strip piece.

Furthermore, on each grounding plate 40F, there are formed attachment holes 42F for attaching the grounding plate 40F to the substrate 20F as rectangular holes penetrating in the plate's thickness direction of the grounding plates 40F, between the upper contact pieces 41FA near the upper edge thereof and between the lower contact pieces 41FB near the lower edge thereof. Those attachment holes 42F are provided corresponding to the attachment protrusions formed on the grounding plates' attachment surfaces of each substrate 20. Each grounding plate 40 is attached to the substrate 20F through engagement of the inner edges (two edges extending in the up-and-down direction) of the attachment holes 42F onto outer edges (two edges extending in the up-and-down direction) of the attachment protrusions.

The female blades 10F having the above-described configuration are made by integral molding to hold the female terminals 30F on the substrates 20F, and then attaching the grounding plates 40F to the substrates 20F. The manufacturing process of the blades 10 will be fully described later part of the specification.

The male blades 10M are different from the female blades 10F in the shapes and arrangements of the male terminals 30M and the shape of the substrates 20M. Hereunder, the male blades 10M will be described mainly focusing on the differences from the female blades 10F and explanation of other parts will be omitted by replacing “F” with “M” in the reference numerals of corresponding parts of the female blades 10F.

As shown in FIGS. 6(A) and 6(B), the substrate 20M of each male blade 10M has an upper end thereof extend higher than the upper ends of the contact sections 31M of the male terminals 30M. The contact sections 31M of the male terminals 30M have straight shape. The contact sections 31M are secured being formed by integral molding onto the substrate 20M so as to have the contact surfaces thereof exposed and then held therein. As shown in FIG. 6(A), the connecting sections 32M are formed by bending at right angles towards the side of the contact surfaces of the contact sections 31M (surfaces exposed from the substrates 20M) in the plate's thickness direction of the male blades 10M. In short, the connecting sections 32M are disposed only on one side that is the same as the terminal arrangement surfaces relative to the terminal arrangement surfaces of the male blades 10M in the plate's thickness direction.

The male terminals 30M have male signal terminals 30MS and male grounding terminals 30MG. Similarly to the female blades 10F, in each male blade 10M, the male signal terminals 30MS and the male grounding terminals 30MG are arranged so as to have the male grounding terminals 30MG disposed on both sides of two male signals terminals that are adjacent to each other. Those two male signal terminals 30MS are configured to transmit high-speed differential signals.

Furthermore, according to the embodiment, as can be understood from comparison between FIGS. 5(A) and 5(B), the order of arrangement of the male signal terminals 30MS and the male grounding terminals 30MG on the male blades 10M is opposite to the order of arrangement of the female signal terminals 30FS and the female grounding terminals 30FG on the female blades 10F. As a result, in the terminals provided on the two blades 10 that are adjacent and face each other in the connector's width direction, the signal terminals provided on one blade 10 face the grounding terminals provided on the other blade in the connector's width direction. Therefore, any pair of signal terminals (a pair of signal terminals that are adjacent to each other in the terminal arrangement direction) are surrounded by the grounding terminals in the terminal arrangement direction and the connector's width direction. Therefore, with increase of shielding effect on the pairs of the signal terminals, it is possible to more securely transmit high-speed differential signals.

From now on, attachment of the blades 10M and 10F to the housing 50 will be described. While the terminal arrangement surfaces of the male blades 10M are directed outward in the connector's width direction (see FIG. 3), the male blades 10M are pressed from thereunder into the blade accommodating sections 57 of the side walls 52 of the housing 50 (see FIG. 7). As such, the press-in protrusions 35FG engage onto the inner wall surfaces of the blade accommodating sections 57, and thereby the blades 10 are attached to the housing 50 (see FIG. 8).

In addition, while the terminal arrangement surfaces of the female blades 10F are directed inward (see FIG. 3), the female blades 10F are pressed in from thereunder into the blade accommodating sections 57 of the side walls 52 of the housing 50 (see FIG. 7). As such, the press-in protrusions 35FG engage onto the inner wall surfaces of the blade accommodating sections 57, and thereby the female blades 10F are attached to the housing 50. As a result, the male blade rows and the female blade rows, which are adjacent to each other, have their terminal arrangement surfaces face each other in the connector's width direction.

In the connector 1, there are provided two rows of the male blades (a row of paired male blades), in which the adjacent blade rows in the connector's width direction have their terminal arrangement surfaces directed opposite to each other in the connector's width direction. However, since the contact sections 31M of the male terminals 30M in each male blade row do not elastically displace, it is not necessary to secure a distance to allow elastic displacement of the contact sections 31M in the connector's width direction. In addition, two female blade rows are provided outside in the connector's width direction, and are not adjacent to each other. Those female blade rows have their terminal arrangement surfaces directed inward in the connector's width direction. Therefore, there is no contact between the contact sections 31F of the elastically displaced female terminals 30F, so that it is not necessary to secure a distance between the female blades 10F to prevent contact between the female terminals 30F. As a result, it is possible to reduce a dimension of the connector 1 in the connector's width direction.

Moreover, in a state the pressing-in of the blades 10M and 10F are completed, as well shown in FIG. 3, the upper end-side sections of the blades 10M and 10F protrude upward from the blade accommodating sections 56 and 57. Between the protruding sections of the male blades 10M and the female blades 10F, the terminal arrangement surfaces of which face each other, there is formed a space. The space forms a receiving section 58 to receive a fitting section 11′ provided on the mating connector 2. Moreover, protruding parts, which protrude upward from the blade receiving sections 57 of the center wall 53, i.e. upper-end side sections of the two male blade rows, which are overlapped in the connector's width direction, form a fitting section 11, which is to be fitted in a receiving section 78 of the mating connector 2, which will be described later.

As well shown in FIG. 3, the connecting sections 32M and 32F extend towards under the blade accommodating sections 56 and 57. In addition, in the blades 10M and 10F, the terminal arrangement surfaces of the male blades 10M are directed outward in the connector's width direction and the terminal arrangement surfaces of the female blades 10F are directed inward in the connector's direction. Therefore, the connecting sections 32M and 32M of the terminals 30M and 30F extend towards outside relative to a center of the connector 1 in the connector's width direction (in a left-and-right direction in FIG. 3).

As described above, according to the embodiment, the connecting sections 32M of the male blades 10M are provided only on one side the terminal arrangement surfaces thereof in the plate's thickness direction of the male blades 10M. The connecting sections 32F of the female blades 10F are provided only on one side of the terminal arrangement surfaces so as to be opposite to be the side of the terminal arrangement surfaces in the other female blade row in the plate's thickness direction of the female blades 10F.

As described above, in case of a conventional connector, where the connector has only a plurality of male blade rows or female blade rows, in order to provide the connecting sections of the terminals of the respective blades only on one side so as to be away from the center of the connector in the connector's width direction, it is necessary to provide two types of blades, positions of connecting sections of which are different, for the male blades and the female blades, respectively.

However, according to the invention, since the connector 1 includes the male blade rows composed by arranging only the male blades 10M and the female blade rows composed only from the female blades 10F. Therefore, it is possible to provide the connecting sections 32M and 32F of the terminals 30M and 30F in any blade rows directed outward from the center of the connector 1 in the connector's width direction. In other words, according to the embodiment, it is necessary to prepare only one type of blades for the male blades 10M and the female blades 10F, so that it is possible to significantly reduce the manufacturing cost in comparison with a case when it is necessary to provide two types of blades in each type of blade, female and male.

In addition, according to the embodiment, the connecting sections of the male blades 10M are provided only on one side, the same side of the terminal arrangement surfaces. The connecting sections 32F of the female blades 10F are provided only on one side, a side opposite the terminal arrangement surfaces of the other female blade row.

Alternatively, it is also possible to configure the blades 10M and 10F, such that the connecting sections 32M of the male blades 10M are provided on only one side, a side opposite the terminal arrangement surfaces of the other male blade row and the connecting sections 32 of the female blades 10F are provided only on one side, the same side of the terminal arrangement surfaces. In other words, the blades 10M and 10F simply need to be configured such that the connecting sections 32M of the male blades 10M and the connecting sections 32F of the female blades 10F are provided on sides opposite to each other to be away from the center in the connector's width direction.

As shown in FIG. 1, the securing metal fittings 60 are respectively held on the bottom wall 51, and connected to corresponding parts of the circuit board. As such, it is possible to improve securing strength of the connector 1 on the circuit board. Each securing metal fitting is made by bending a metal strip piece at right angle outward in the blade arrangement direction, and includes a section to be held 61, which extends in the up-and-down direction and is held by the bottom wall 51, and a securing section 62, which extends in the blade's arrangement direction and is to be secured on the circuit board. Being pressed in the sections to be held 61 from thereunder, the securing metal fittings 60 are attached onto the bottom wall 51.

Next, referring to FIGS. 1 through 4, the mating connector 2 will be described. The mating connector 2 includes the above-described plurality of blades 10, the housing 70 that is a holding member to arrange and hold the plurality of blades 10, and metal fittings 80 to be held in the housing 70. As such, the mating connector 2 has the common blades 10 with the connector 1, it is possible to reduce the manufacturing cost. Hereunder, in order to clearly distinguish from the blades of the connector 1, the blades 10 provided in the mating connector 2 will be described affixing “′” after the reference numeral.

As shown in FIGS. 1 through 4, the mating connector 2 is fitted and connected to the connector 1 from thereabove, while being oriented to be up-side-down relative to the connector 1, i.e. with a bottom wall 71 thereof, which will be described later, is directed upward.

The housing 70 is formed as generally rectangular parallelepiped, which extends having one direction parallel to a mounting surface of a circuit board as a longitudinal direction thereof. Corresponding to the blades 10 of the connector 1, the housing 70 arranges and holds four blades 10′ with the longitudinal direction being blade arrangement direction, and holds four rows of the blades, each row of which is composed arranging four blades, in the connector's width direction (lateral direction of the housing 70).

The housing 70 includes a bottom wall 71 that faces the mounting surface of the circuit board, two side walls 72 that rise from the bottom wall 71 and extends in the blade arrangement direction, and two end walls 73 that rise from the bottom wall 71, extends between the two side walls 72 in the longitudinal direction, and join end sections of the two side walls 72. In addition, the housing 70 further includes a center wall 74 (see FIGS. 3 and 4) that rises from the bottom wall 71, extends in the longitudinal direction, and joins the end walls 73, and dividing walls 79, which extend in the connector's width direction and join the side walls 72 and the center wall 74, corresponding to between blades that adjacent to each other in the blade's arrangement direction.

As shown in FIG. 1, the end walls 73 are formed such that the dimension of lower parts thereof in the connector's width direction is smaller than the dimension of upper parts thereof in the connector's width direction. Hereunder, the upper parts of the end walls 73 in FIG. 1 are referred to as “wide sections 73A”, and the lower parts thereof are referred to as “narrow sections 73B”. Outer surfaces of the wide sections 73A (surfaces perpendicular to the connector's width direction) are recessed from the outer surfaces of the side walls 72. As shown in FIG. 2, upon fitting the connectors, the narrow sections 73B enter the concave sections formed between the end sections of the side walls 52 of the connector 1.

As shown, FIG. 1, the narrow sections 73B have the lower sections provided below the side walls 72 and the center wall 74, and the lower sections have tapered shapes having slanted surfaces that slope in the blade arrangement direction and the connector's width direction. Those slanted surfaces work as guide sections when the narrow sections 73B enter the concave sections 55.

As shown in FIG. 3, the inner wall sections 72A of the side walls 72, inner parts thereof, are formed to be higher than the outer wall sections 72B, outer parts thereof, i.e. extend downward lower than the outer wall sections 72B in FIG. 3, and have step-like shapes when viewed in the blade arrangement direction (a direction perpendicular to the paper surface of FIG. 3). The inner wall sections 72A are formed to have the same dimensions as the blades 10′ in the up-and-down direction. On the outer wall sections 52B, there are formed blade accommodating sections 76 for accommodating and holding the blades 10′. Those blade accommodating sections 76 are formed for four in the blade arrangement direction. Each blade accommodating section 76 is formed to have generally the same dimension as one blade 10″ in the blade arrangement direction and the connector's width direction. Therefore, in each blade accommodating section 76, one male blade 10M′ is to be accommodated.

As shown in FIG. 3, the center wall 74 is formed to have the same dimensions as the inner wall sections 72A of the side walls 72 and the blade 10′ in the up-and-down direction. A lower surface of the center wall 74 is provided at the same height level as those of lower surfaces of the inner wall sections 72.

On the center wall 74, blade accommodating sections 77 for accommodating and holding the blades 10′ are formed as holes penetrating also the bottom wall 71 in the up-and-down direction. The blade accommodating sections 77 are formed being arranged in four rows in the blade arrangement direction. Each blade accommodating section 77 has generally the same dimension as one blade 10′ in the blade arrangement direction and has the same dimension as two blades 10′ in the connector's width direction. As well shown in FIG. 3, in each blade accommodating section 77, two female blades 10F′ are accommodated with their plates' surfaces putting together.

Into the blade accommodating sections 76 and 77, blades 10′ are pressed from thereabove in FIG. 1 (see FIG. 7), and held by press-in protrusions 35MG′ and 35FG′ provided on both side edges (edges extending in the up-and-down direction) of the blade 10″.

In addition, the dividing walls 79 are formed to have substantially the same dimensions as the outer wall sections 72B of the side walls 72. Lower surfaces of the dividing walls 79 are located at the same height level as lower surfaces of the outer wall sections 72B.

According to the embodiment, any blades 10′ held in the blade accommodating sections 76 are male blades 10M′, and any blades held in the blade accommodating sections 77 are female blades 10F′. In short, the blade rows held in the side walls 72 are male blade rows composed by arranging only the male blades 10M′, and the blade rows held by the center wall 74 are female blade rows composed by arranging only the female blades 10F′.

In order to attach the male blades 10M′ to the housing 50, with terminal arrangement surfaces of the male blades 10M′ are directed outward in the connector's width direction (see FIG. 3), the male blades 10M′ are pressed in the blade accommodating sections 76 of the housing 50 from thereabove in FIG. 1 (see FIG. 7), and the press-in protrusions 35MG′ engage onto inner wall surfaces of the blade accommodating sections 76. On the other hand, in order to attach the female blades 10F′ to the housing 50, with the terminal arrangement surfaces are directed so as to be away from the center in the connector's width direction (see FIG. 3), the female blades 10F′ are pressed in the blade accommodating sections 77 from thereabove in FIG. 1 (see FIG. 7), and the press-in protrusions 35FG′ engage onto inner wall surfaces of the blade accommodating sections 77. As a result, the female blade rows, which are adjacent to each other, have their respective terminal arrangement surfaces face opposite side to each other in the connector's width direction.

In the mating connector 2, since there is no blade rows (blade row pair) that are adjacent to each other having their respective terminal arrangement surfaces face each other in the connector's width direction, there cannot be any contact between female terminals 30F′ (between the contact sections 31F′) of the elastically displaced female blade 10F′. In other words, there is no need to secure a distance between the female blades 10F′ in order to prevent contact between the female terminals 30F′. Therefore, it is possible to reduce the dimension of the mating connector 2 in the connector's width direction.

Furthermore, as in FIG. 3, in a state the blades 10M′ and 10F′ are completely pressed in, the blades 10M′ and 10F′ have their lower-side parts protrude downward from the blade accommodating sections 76 and 77. Lower parts of the inner wall section 72A, the center wall 74, and the blades 10M′ and 190F′ which protrude downward lower than lower surfaces of the side walls 72, form a fitting section 11′. The fitting section 11′ is to be fitted in a receiving section 58 of the connector 1 upon fitting the connectors. In other words, as shown in FIG. 3, the mating connector 2 has two fitting sections 11′. Moreover, space formed between the fitting sections 11′, i.e., space formed between lower parts of the female blades 10F′, form a receiving section 78 to receive the fitting sections 11 of the connector 1 upon fitting the connectors 1 and 2.

Furthermore, as shown in FIG. 3, the connecting sections 32M′ and 32F′ extend upward from the blade accommodating sections 76 and 77. In addition, the male blades 10M′ have their terminal arrangement surfaces directed outward in the connector's width direction, and the female blades 10F′ have their terminal arrangement surfaces directed so as to be away from the center in the connector's width direction. As such, the connecting sections 32M′ and 32F′ of the terminals 30M′ and 30F′ extend outward relative to centers in the connector's width direction (the left-and-right direction in FIG. 3).

Next, referring to FIGS. 1 through 4, fitting and connecting of the connector 1 and the mating connector 2 will be described. First, the connector 1 and the mating connector 2 are mounted on mounting surfaces of respective corresponding circuit boards (not illustrated). Then, as shown in FIGS. 1 and 3, the connector 1 is oriented so as to have the fitting sections 11 of the connector 1 (see FIG. 3) direct upward, and the mating connector 2 is oriented so as to have the fitting section 11′ of the mating connector 2 (see FIG. 3) direct downward. Thereafter, the mating connector 2 is brought above the connector 1 and then moved down (arrows in FIGS. 1 and 3).

Once the mating connector 2 is moved down, the narrow sections 73B of the end walls 73 of the mating connector 2 are guided with lower end sections of the narrow sections 73B to enter in the concave sections 55 of the connector 1. As such, the fitting section 11′ and the receiving section 78 of the mating connector 2 are positioned relative to the receiving section 58 and the fitting sections 11 of the connector 1.

When the mating connector 2 is moved downward, the fitting sections 11′ of the mating connector 2 enter the receiving section 58 of the connector 1 from thereabove. At the same time, the fitting sections 11 of the connector 1 enter the receiving section 78 from thereunder. Then, the contact sections 31M′ of the male terminals 30M′ of the male blades 10M′ provided in the mating connector 2 contact with the contact sections 31F of the female blades 10F of the connector 1. The contact sections 31F are elastically displaced outward in the connector's width direction (see FIG. 4). On the other hand, the contact sections 31F′ of the female terminals 30F′ of the female blades 10F′ provided in the mating connector 2 contact with the contact sections 31M of the female blades 10M of the connector 1, and are elastically displaced so as to be away from the center in the connector's width direction (see FIG. 4).

As shown in FIG. 4, in a state the connector fitting is completed, the state of the elastic displacements of the contact sections 31F and 31F′ are maintained. The contact sections 31F and 31F′ and the contact sections 31M′ and 31M, which contact to each other at certain contact pressure, are electrically connected to each other.

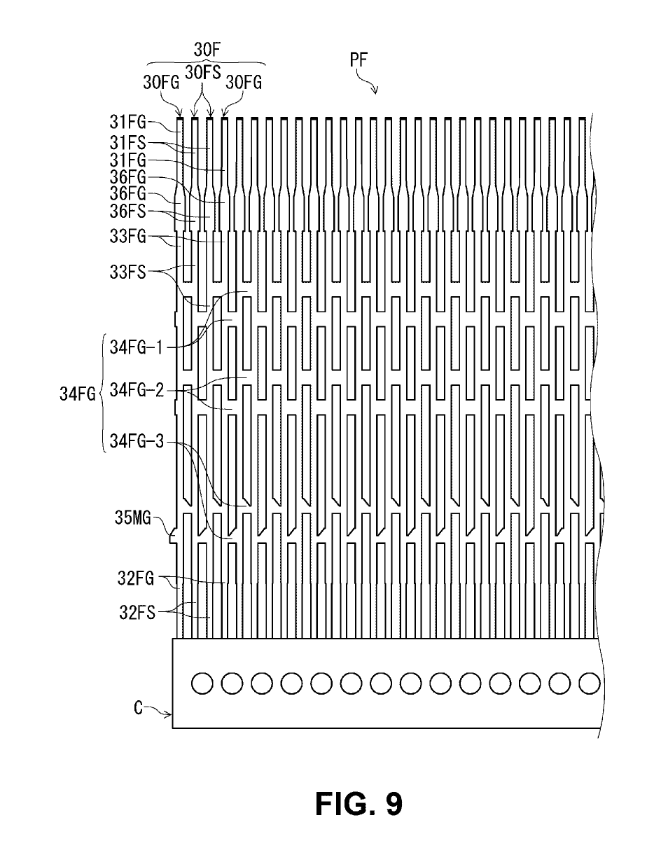

Next, referring to FIGS. 9 through 12, manufacturing steps of the blades 10 will be described. In this part, manufacturing steps of the female blades 10F will be described, but the manufacturing steps of the male blades 10M are basically the same as those of the female blades 10F.

First, terminal materials PF for female terminals 30F are prepared as shown in FIG. 9. Each terminal material PF is made by punching sheet metal in plate's thickness direction thereof, while keeping flat surfaces thereof. In FIG. 9, reference numerals of respective parts are put to corresponding parts of the female blades 30F. In the terminal material PF, a number of strip pieces extending in the up-and-down direction is arranged so as to be parallel to each other. Any strip pieces that are adjacent to each other are joined with upper joining sections 34F-1, middle joining sections 34F-2, and lower joining sections 34F-3. Here, in order to refer any joining sections without limiting to the joining sections that join strip pieces of the female grounding terminals, the reference numerals of the joining sections are presented as “upper joining sections 34F-1”, “middle joining sections 34F-2”, and “lower joining sections 34F-3”. In addition, those joining sections 34F-1, 34F-2, and 34F-3 are also generally termed as “joining sections 34F’. Moreover, each terminal material PF is joined to a carrier C at lower end thereof in FIG. 9, i.e., a lower end that correspond to the connecting sections 32F.

Here, according to the embodiment, the strip pieces of the terminal material PF are joined by the joining sections 34F at three locations in the up-and-down direction. However, the number of the joining sections 34F in the up-and-down direction is not limited to this, and the number can be any as long as it is at least one.

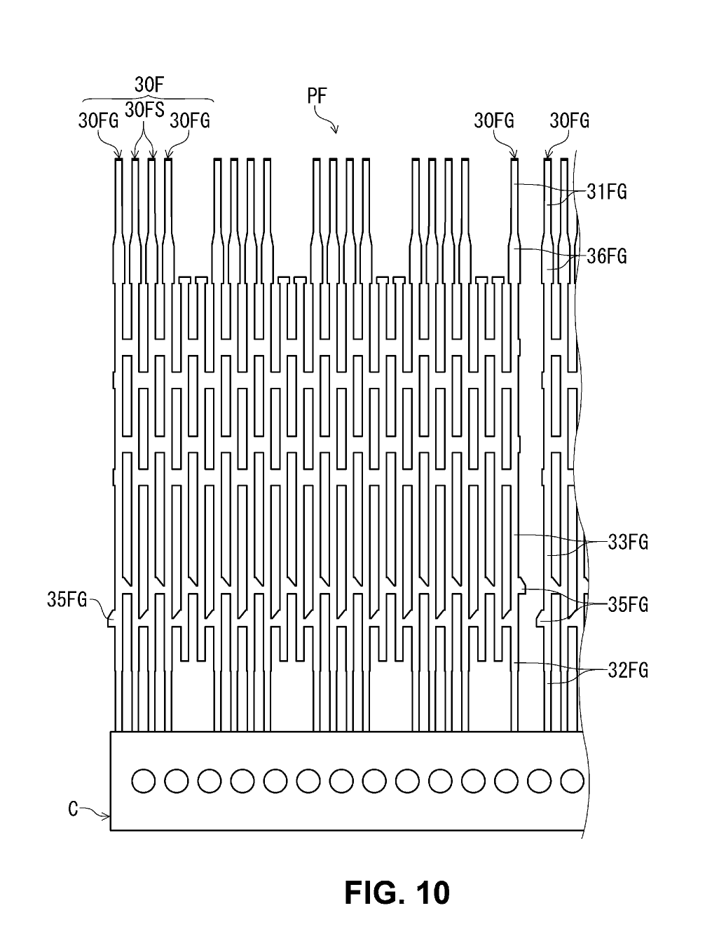

Next, the terminal material PF is cut to form the female terminals 30F in the number to be provided in one female blade 10F. For example, according to the embodiment, as shown in FIG. 5(A), the total number of strip pieces of the female terminals 30F provided in one female blade 10F is 25. Therefore, as shown in FIG. 10, removing the 26th strip piece from the left, the terminal materials PF having 25 strip pieces are formed.

Upon removing the 26th strip piece, as shown in FIG. 10, the upper joining section 34F-1 and the middle joining section 34F-2 are cut at a position near the strip pieces adjacent to the 26th strip piece (the 25th and the 27th strip pieces) in the terminal arrangement direction (the left-and-right direction in FIG. 10), and the lower joining section 34F-3 is cut at a position close to the 26th strip piece in the terminal arrangement direction. As a result, as shown in FIG. 10, at the right edge of the 25th strip piece, the upper joining section 34F-1 and the middle joining section 34F-2 are removed, but the lower joining section 34F-3 is not removed. As such, the press-in protrusion 35FG is formed by the lower joining section 34F-3.

Furthermore, according to the embodiment, at the same time as cutting the terminal material PF as described above, as shown in FIG. 10, the upper-end parts and the lower-end parts of the two strip pieces provided inside among the four strip pieces of the female grounding terminal 30FG are removed by punching process.

According to the embodiment, as described above, the joining sections 34F are arranged in a staggered manner in the terminal arrangement direction. In short, the joining section 34F joined on the left edge of the 26th strip piece to be removed and the joining section 34F joined on the right edge are displaced from each other, so as to be located higher and lower, respectively. Therefore, upon cutting to separate the 26th strip piece and the lower joining section 34F-3, it is possible to disperse stress generated upon the cutting in the up-and-down direction. Accordingly, it is possible to reduce the width range of the terminal arrangement in the terminal arrangement direction in the respective female blades 10, and thereby it is possible to prevent increase of the size of the female blades 10F in the terminal arrangement direction.

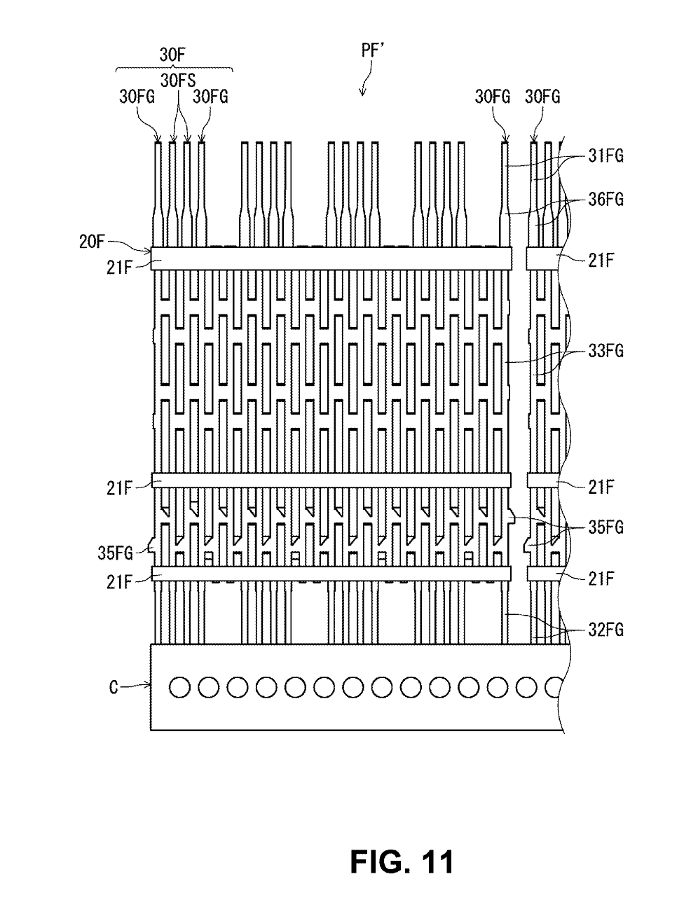

Next, after placing the terminal material PF having 25 strip pieces into a mold (not illustrated), resin to form the substrate 20F is poured into the mold. Then, the resin is integrally molded. As a result, as shown in FIG. 11, an intermediate fabrication member PF′, which is obtained by integrally molding the terminal material PF and the substrate 20F, is obtained. Thereafter, as shown in FIG. 12, the joining section between adjacent female signals terminals 30FS and the joining section between adjacent signal terminal 30FS and the female grounding terminal are removed by punching process. According to the embodiment, since the substrate 20F does not have holes corresponding to the respective joining sections, upon performing the punching process, it is possible to remove the joining sections 34F by passing the punching member through the holes.

In addition, as shown in FIG. 12, the contact sections 31F and the connecting sections 32F are formed by cutting to separate the lower ends of the respective strip pieces from the carrier C and bending the upper end parts and the lower end parts of the respective strip pieces in the plate's thickness direction (the direction perpendicular to the paper surface of FIG. 12). At this time, the contact sections 31F are bent to protrude towards over the paper surface. The connecting sections 32F are bent to protrude towards before the paper surface (opposite to the protruding direction of the contact sections 31F across the paper surface of FIG. 12). Then, attaching the grounding plate 40F to the grounding plate attachment surface of the substrate 20F, the female blade 10F is completed.

The manufacturing process of the male blades 10M is basically the same as the above-described manufacturing process of the female blades 10F, except that the substrates 20M are integrally molded also with the upper end parts.

According to the embodiment, in the blades 10, in order to use for transmission of high-speed differential signals, two signal terminals, each of which is formed of one strip piece, are put so as to be adjacent to each other. On both sides of those two signal terminals, grounding terminals, each of which is formed by joining four strip pieces, are arranged respectively. As will be described below, changing the shapes of the terminals and the terminal arrangement, it is possible to use for various types of signals.

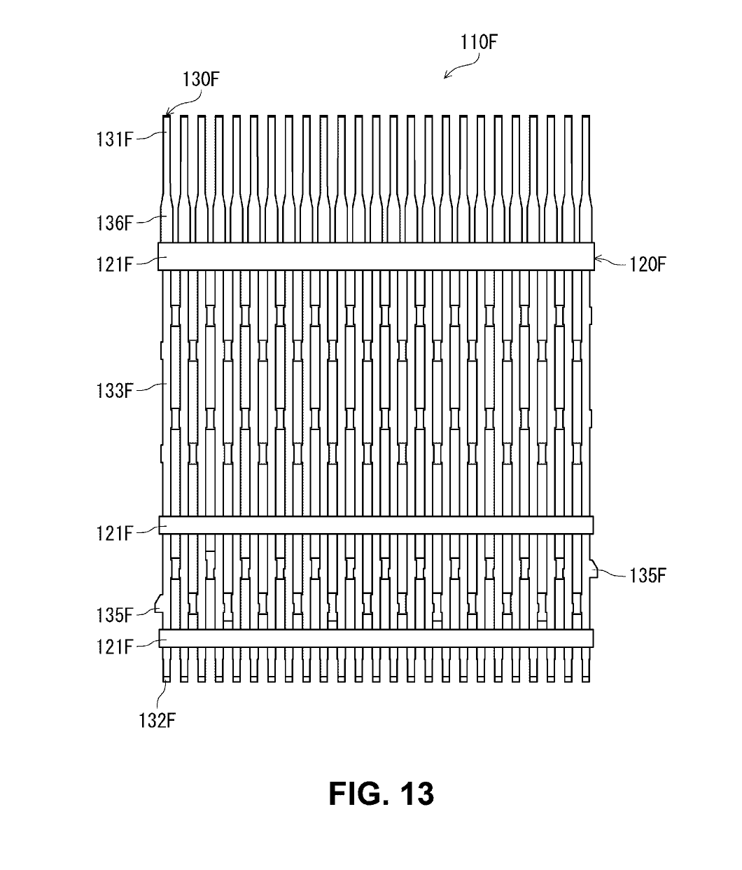

FIG. 13 is a front view of the female blade 110F according to a modification example of the embodiment, which is viewed from a side of a terminal arrangement surface thereof. In FIG. 13, any joining sections between adjacent strip pieces are removed, and each female terminal is made of one strip piece. According to the female blade 110F, for example, using two adjacent female terminals 130F as signal terminals and using female terminals located on both sides of the two signal terminals as grounding terminals, i.e., by arranging alternately in the order of ground terminal, signal terminal, and signal terminal, it is possible to use for transmission of high-speed signals. In addition, using all the female terminals 130F as signal terminals, it is also possible to use for transmission of low-speed signals, in which transmission rate is slower than that of high-speed signals.

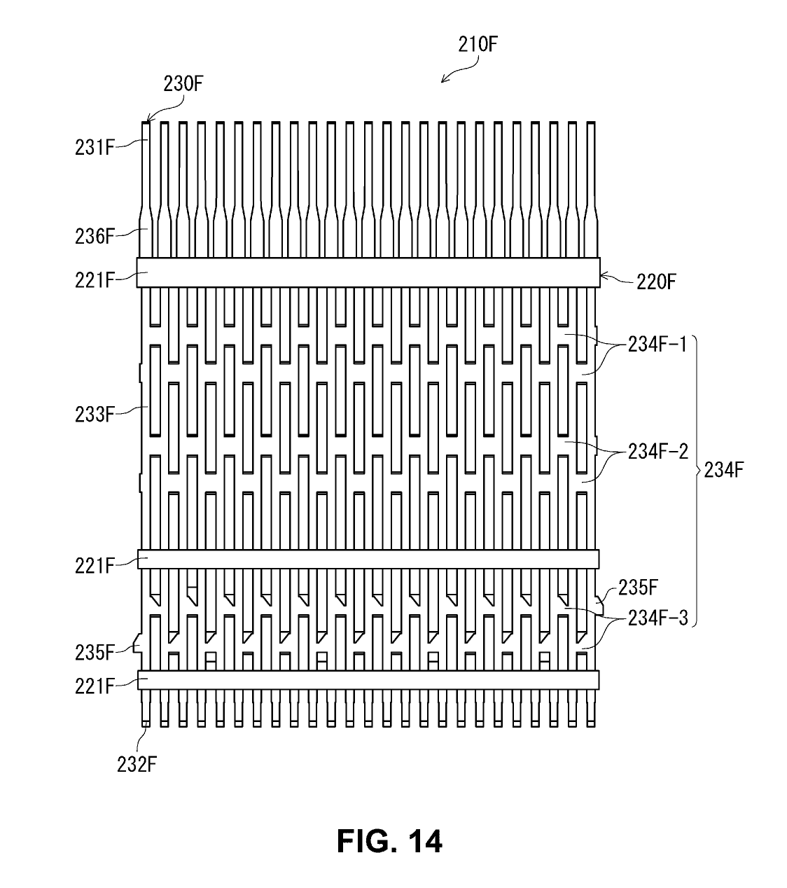

FIG. 14 is a front view of the female blade 210F according to another modification example of the embodiment, which is viewed from a side of a terminal arrangement surface thereof. In FIG. 14, parts corresponding to those of the female blade 10F are indicated with the same reference numerals thereof but affixed with “200”. According to the modification example of FIG. 14, the joining sections are not removed in the manufacturing process of the female blade 210F. The female blade 230F forms one sheet metal member, in which all the strip pieces are joined. The female terminals 230F may be used, for example, as power source terminals or grounding terminals.

As described above, according to the embodiment, it is possible to make a plurality of types of terminals according to characteristics of signals to transmit from one type of terminal material PF. Therefore, it is possible to significantly reduce the manufacturing cost. Moreover, even when the necessary total number of strip pieces to make terminals to be held in each blade is increased/decreased due to change of the design, it is still possible to make various types of female terminal blades by cutting out the total number of strip pieces from the terminal material PF and suitably selecting and removing at least one joining section or by not removing the joining sections according to the characteristics of signals to transmit. Therefore, it is possible to significantly reduce the manufacturing cost. In addition, in the modification examples of FIGS. 13 and 14, the female blades are described, but needless to say, it is also possible to apply those modification examples in male blades.

According to the embodiment, four blades are arranged in each blade row, but the number of blades in each row is not limited to this. The number of blades in each row can be suitably set to any. Moreover, four blade rows are respectively provided in the connector and the mating connector, but the number of blade rows is not limited to this. The number of blade rows can be three or even five or larger. The effect of downsizing of the connector and the mating connector in the connector's width direction according to the invention can be greater as the number of blade rows is larger.

According to the embodiment, in the connector 1, two blade rows on an inner side in the connector's width direction are male blade rows, and two blade rows provided on outer sides are female blades. In the mating connector 2, two blades provided on an inner side thereof are female blade rows and two blade rows provided on outer sides thereof are male blades. However, the arrangement of the male blade rows and the female blade rows can be suitably set. In addition, the blade rows provided in the male blade rows and the female blade rows are the homo blade rows, which are composed of one type of blades, i.e., male blades rows or the female blade rows. Yet, alternatively, at least one of the blade rows can be mixed blade row(s), hetero blade row(s), in which the male blade and the female blades are suitably mixed.

According to the embodiment, pressing desired blades in the respective blade accommodating sections of the housing, it is possible to freely change the arrangement of the blades. Therefore, it is possible to easily deal differences among designs. At this time, in case of a pair of blade rows composed of two blade rows that are adjacent to each other having the terminal arrangement surfaces of the blades provided opposite to each other in the connector's width direction, it is necessary to arrange the male blades in the both blade rows at the same positions in the blade arrangement direction or to arrange the male blades in one blade row and arrange female blades in the other row. Arranging the respective blade this way, female blades will not be arranged in the both blade rows at the same positions in the blade arrangement direction. Therefore, in the pair of blade rows, there cannot be any contact between the terminals of the elastically displaced female blades. As a result, it is not necessary to secure a distance between the female blades to prevent contact between female terminals of the female blades. Accordingly, it is possible to reduce dimensions of the intermediate electrical connector and the mating connector in the connector's width directions.

Furthermore, according to the embodiment, blades intended only for signals of one characteristic, high-speed signals, are provided. Alternatively, for example, as shown in FIGS. 13 and 14, mixing different types of blades according to characteristics of signals to transmit, it is possible to transmit various types of signals by one connector.

The connector of the embodiment is described as an intermediate electrical connector to relay between a circuit board as a mating connecting body and a mating connector as another connecting body. Alternatively, the connector can be an intermediate electrical connector, for example, to relay between two mating connectors with the mating connectors as mating connecting bodies are fitted and connected from thereabove and thereunder. In this case, on both the upper end side and lower end side of the terminals of the blades, there are provided contact sections for connecting to mating terminals provided in the respective mating connectors.

The disclosure of Japanese Patent Applications No. 2013-160733, filed on Aug. 1, 2013, is incorporated in the application by reference.

While the present invention has been explained with reference to the specific embodiments of the present invention, the explanation is illustrative and the present invention is limited only by the appended claims.

What is claimed is:

1. An intermediate electrical connector, comprising:
a plurality of blades including a male type blade and a female type blade; and
a holding member for holding the blades along a blade arrangement direction,
wherein said male type blade includes a plurality of first terminals disposed thereon,
each of said first terminals includes a first contact portion disposed on a first terminal arrangement surface of the male type blade,
said female type blade includes a plurality of second terminals disposed thereon,
each of said second terminals includes a second contact portion disposed a second terminal arrangement surface of the female type blade,
said holding member includes a first holding portion for holding the male type blade, a second holding portion for holding the female type blade, and a third holding portion for holding the male type blade or the female type blade,
said first holding portion is situated adjacent to the second handling portion, and
said first holding portion is arranged to hold the male type blade so that the first terminal arrangement surface is opposite to the second terminal arrangement surface of the female type board in the second holding portion.

2. The intermediate electrical connector according to claim 1, wherein said first holding portion is arranged to hold the male type board so that the male type board is situated at a position along the blade arrangement direction the same as that of the female type board in the second holding portion.

3. The intermediate electrical connector according to claim 1, wherein said female type blade includes the second terminals arranged in at least one of a first arrangement, a second arrangement, and a third arrangement according to a characteristic of a signal to be transmitted.

4. The intermediate electrical connector according to claim 1, wherein each of said first terminals includes a first upper band shape portion, a first lower band portion, and a first connecting portion formed between the first upper band portion and the first lower band portion, and
each of said second terminals includes a second upper band shape portion, a second lower band portion, and a second connecting portion formed between the second upper band portion and the second lower band portion.

5. The intermediate electrical connector according to claim 1, wherein said male type blade further includes a first protruding portion to be pressed against the first holding portion, and
said female type blade further includes a second protruding portion to be pressed against the second holding portion.

6. The intermediate electrical connector according to claim 1, wherein said male type blade further includes a first upper protruding portion to be pressed against the holding member and a first lower protruding portion to be pressed against the holding member,
said first upper protruding portion is formed on one side of the male type blade,
said first lower protruding portion is formed on an opposite side of the male type blade,
said female type blade further includes a second upper protruding portion to be pressed against the holding member and a second lower protruding portion to be pressed against the holding member,
said second upper protruding portion is formed on one side of the female type blade, and
said second lower protruding portion is formed on an opposite side of the female type blade.

7. The intermediate electrical connector according to claim 1, wherein each of said first terminals further includes a first connecting portion curved toward the first terminal arrangement surface, and
each of said second terminals further includes a second connecting portion curved opposite to the second terminal arrangement surface.

8. The intermediate electrical connector according to claim 1, wherein each of said first terminals further includes a first signal terminal and a first ground terminal disposed adjacent to the first signal terminal, and
each of said second terminals further includes a second signal terminal and a second ground terminal disposed adjacent to the second signal terminal.

9. The intermediate electrical connector according to claim 8, wherein said first holding portion is arranged to hold the male type board and said second holding portion is arranged to hold the female type board so that the first signal terminal faces the second ground terminal.

10. The intermediate electrical connector according to claim 1, wherein said holding member further includes a fourth holding portion for holding the male type blade and/or the female type blade.

11. The intermediate electrical connector according to claim 1, wherein said third holding portion is situated adjacent to the first handling portion, and
said third holding portion is arranged to hold the male type blade so that the first terminal arrangement surface is opposite to the first terminal arrangement surface of the male type board in the first holding portion.

12. An electrical connector assembled member, comprising:
an intermediate electrical connector; and
a mating connector connected to the intermediate electrical connector,
wherein said intermediate electrical connector comprising:
a plurality of blades including a male type blade and a female type blade; and
a holding member for holding the blades along a blade arrangement direction,
wherein said male type blade includes a plurality of first terminals disposed thereon,
each of said first terminals includes a first contact portion disposed on a first terminal arrangement surface of the male type blade,
said female type blade includes a plurality of second terminals disposed thereon,
each of said second terminals includes a second contact portion disposed a second terminal arrangement surface of the female type blade,
said holding member includes a first holding portion for holding the male type blade, a second holding portion for holding the female type blade, and a third holding portion for holding the male type blade or the female type blade,
said first holding portion is situated adjacent to the second handling portion, and
said first holding portion is arranged to hold the male type blade so that the first terminal arrangement surface is opposite to the second terminal arrangement surface of the female type board in the second holding portion.
